(19) United States
(12) Patent Application Publication
(10) Pub. No.: US 2014/0289483 A1
(43) Pub. Date: Sep. 25, 2014

(54) SHARED MEMORY CONTROL UNIT HAVING LOCK TRANSACTION CONTROLLER

(71) Applicant: KABUSHIKI KAISHA TOSHIBA, Tokyo (JP)

(72) Inventors: Sohichiroh HOSODA, Kawasaki-shi (JP); Jun TANABE, Yokohama-shi (JP); Hiroyuki USUI, Pittsburgh, PA (US)

(73) Assignee: KABUSHIKI KAISHA TOSHIBA, Tokyo (JP)

(21) Appl. No.: 14/223,248

(22) Filed: Mar. 24, 2014

(30) Foreign Application Priority Data
Mar. 25, 2013 (JP) 2013-061889

(51) Int. Cl. G06F 12/14

(52) U.S. Cl. CPC G06F 12/1475
USPC 711/152

(57) ABSTRACT

A shared memory controller controls access to a shared memory by a plurality of master devices based on access requests received from the plurality of master devices. The shared memory control unit includes a memory access arbiter that receives a lock reading request to lock a portion of shared memory, a waiting queue that stores the access requests, and a lock transaction controller. The lock transaction controller receives a plurality of access requests after the lock reading request is received by the memory access arbiter. The lock transaction controller stores the access requests in the waiting queue, and receives an unlock writing request to unlock the portion of shared memory. After the portion of shared memory is unlocked, the lock transaction controller releases the access requests from the waiting queue.

### CROSS-REFERENCE TO RELATED APPLICATION

This application is based upon and claims the benefit of priority from Japanese Patent Application No. 2013-061889, filed Mar. 25, 2013, the entire contents of which are incorporated herein by reference.

### FIELD

Embodiments described herein relate to a shared memory control unit having a lock transaction controller.

### BACKGROUND

Conventionally, shared memory systems include a large number of master devices (for example, many core processors or hardware engines), a shared memory that is shared in common by the master devices, a large number of routers, and an interconnect that connects these devices to each other.

In such systems, when the master devices access the shared memory and issue a “test and set” (TAS) request for a portion of the shared memory via the interconnect, the TAS requests from the master devices often compete and interfere with each other. Hence, each master device must reissue a previously issued TAS request.

In other cases, one master device (hereinafter referred to as “locking master device”) reserves a locked region in the shared memory, while other master devices (hereinafter, referred to as “non-locking master devices”) repeatedly reissue TAS requests until the locked region is released. In these cases, the interconnect is overburdened by the transfer of data relating to lock processing and, hence, data transfer efficiency is lowered. In this case, even when the locking master device issues a write request to release the locked region, the transmission of the write request is obstructed by the transmission of TAS requests reissued by the non-locking master devices and, hence, the release of the locked region is delayed.

### DESCRIPTION OF THE DRAWINGS

FIG. 1 is a block diagram of a multiprocessing system according to an embodiment.

FIG. 2 is a block diagram of a shared memory control unit according to the embodiment.

FIG. 3 is a block diagram of a lock transaction controller that supports a single writing request according to the embodiment.

FIG. 4 is a block diagram of the lock transaction controller that supports a burst writing request according to the embodiment.

FIG. 5 is a flowchart showing the transition among states by a state machine according to the embodiment.

FIG. 6 is a block diagram showing how data is transferred in the shared memory control unit when the flow of lock transaction of the embodiment is executed.

FIG. 7 is a block diagram showing the manner how data is transferred in the shared memory control unit when the flow of the lock transaction of the embodiment is executed.

FIG. 8 is a block diagram showing the manner how data is transferred in the shared memory control unit when the flow of the lock transaction of the embodiment is executed.

FIG. 9 is a block diagram showing the manner how data is transferred in the shared memory control unit when the flow of the lock transaction of the embodiment is executed.

FIG. 10 is a block diagram showing the manner how data is transferred in the shared memory control unit when the flow of the lock transaction of the embodiment is executed.

FIG. 11 is a block diagram showing the manner how data is transferred in the shared memory control unit when the flow of the lock transaction of the embodiment is executed.

### DETAILED DESCRIPTION

According to an embodiment, there is provided a system that includes a plurality of master devices and a shared memory, and that improves data transfer efficiency.

In one embodiment, a shared memory control unit that controls access to a shared memory by a plurality of master devices based on access requests received from the plurality of master devices is provided. The shared memory control unit comprises a memory access arbiter that receives a lock reading request to lock a portion of the shared memory, awaiting queue that stores the access requests, and a lock transaction controller. The lock transaction controller is configured to receive a plurality of access requests after the lock reading request is received by the memory access arbiter. The lock transaction controller is further configured to store the access requests in the waiting queue and to receive an unlock writing request to unlock the portion of shared memory. The lock transaction controller is further configured to release the access requests from the waiting queue after the portion of shared memory is unlocked.

According to an embodiment, there is provided a system having a plurality of master devices and a shared memory that improves data transfer efficiency.

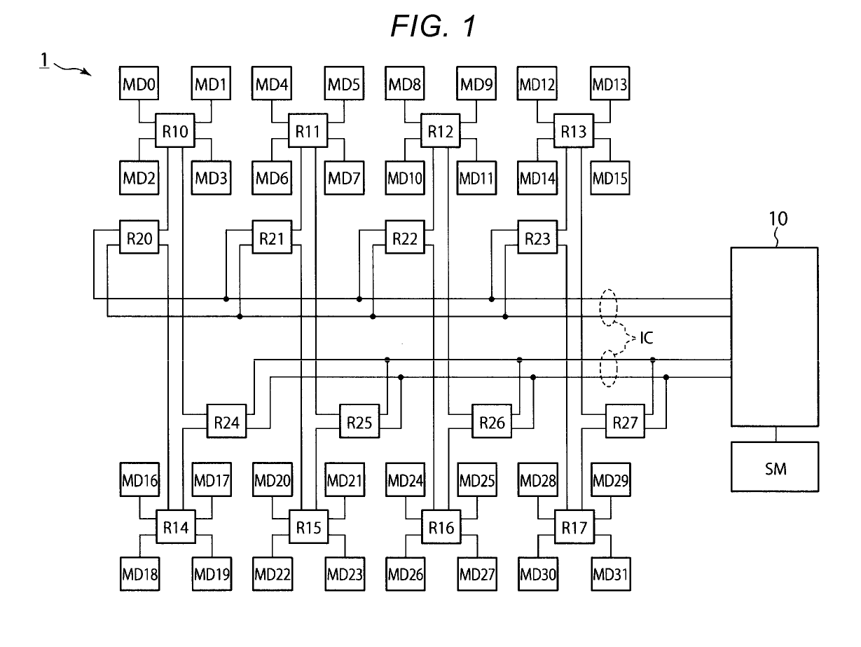

The configuration of a multiprocessing system of a first embodiment is explained. FIG. 1 is a block diagram of a multiprocessing system 1 of this embodiment. The multiprocessing system 1 includes: a plurality of master devices MD0 to MD31 (hereinafter also referred to as “MD”); a plurality of first level routers R10 to R17 (hereinafter also referred to as “R1”); a plurality of second level routers R20 to R27 (hereinafter also referred to as “R2”); a Network on Chip (NoC)-type interconnect IC; a shared memory control unit 10; and a shared memory SM.

The respective master devices MD (for example, MD0 to MD3) are devices connected to each other via a first level router R1 (for example, R10), and comprise a processing unit or a hardware engine, for example. The first level router R1 (for example, R10) is connected to another first level router R1 (for example, R14) and the second level router R2 (for example, R20). The second level router R2 (for example, R20) is connected to other second level routers R2 (for example, R21 to R23) and to the shared memory control unit 10 via the interconnect IC.

The master devices MD perform data processing by obtaining access to the shared memory SM. The first level router R1 and the second level router R2 perform a routing control of data which a master device MD transmits or receives. The shared memory control unit 10 controls access to the shared memory SM. The shared memory SM stores data to be processed by the master devices MD therein.

FIG. 1 shows an example of a network topology where the number of ports of the shared memory control unit 10 is 4, the number of master devices MD is 32, and all devices are connected to the shared memory SM via the tree-structured interconnect IC. However, the number of ports, the number of master devices MD, and the network topology are not limited to this example.

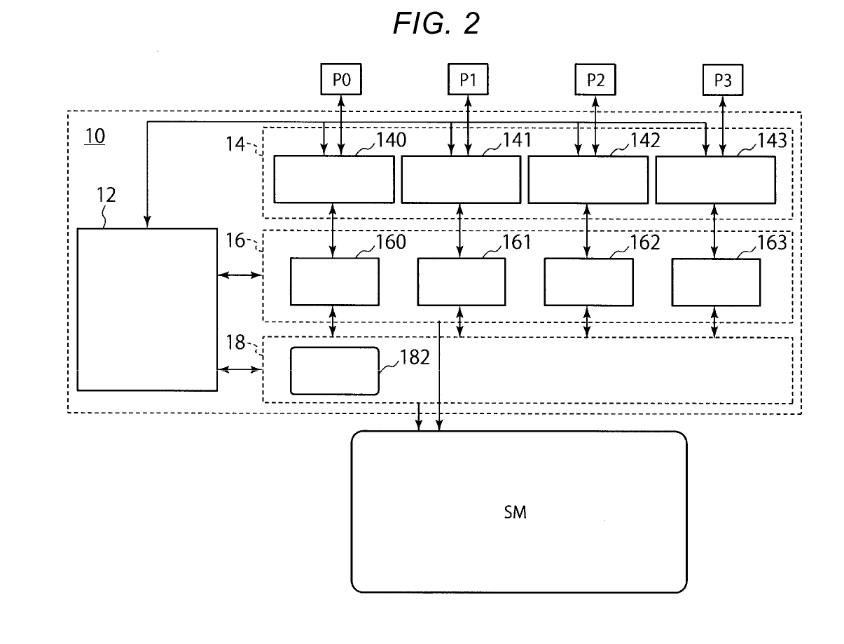

FIG. 2 is a block diagram of the shared memory control unit 10 according to the first embodiment. The shared memory control unit 10 includes: a plurality of ports P0 to P3; a lock transaction controller 12; a plurality of memory access bridges 140 to 143; a plurality of memory access parts 160 to 163; and a memory access arbiter 18.

The ports P are interfaces between the interconnect IC and the shared memory control unit 10. The lock transaction controller 12 controls lock transactions for the shared memory SM. Specifically, the lock transaction controller 12 controls a read access from and a write access to a locked region, and performs processing to reissue a new lock reading request that arrives during a locking operation, after putting the new lock reading request into a wait state. An example of a lock reading request is the test portion of a Test and Set (TAS) request.

The memory access bridges 140 to 143 and the memory access parts 160 to 163 correspond to the ports P0 to P3, respectively. The memory access bridges 140 to 143 receive access requests from the master devices MD via the ports P0 to P3. When the access requests which the memory access bridges 140 to 143 receive are reading requests, the memory access parts 160 to 163 hold the reading requests, while, when an access request is a writing request, the memory access parts 160 to 163 hold the writing request and writing data accompanying the writing request.

The memory access arbiter 18 arbitrates an access request that the memory access bridges 140 to 143 receive. The memory access arbiter 18 includes a lock information storage part 182. The memory access arbiter 18 stores lock information used for locking the shared memory SM in the lock information storage part 182 when the access request is a lock reading request. Although the lock information storage part 182 is disposed within the memory access arbiter 18 in FIG. 2, the lock information storage part 182 may be disposed at an arbitrary place along a path through which a lock request is transmitted.

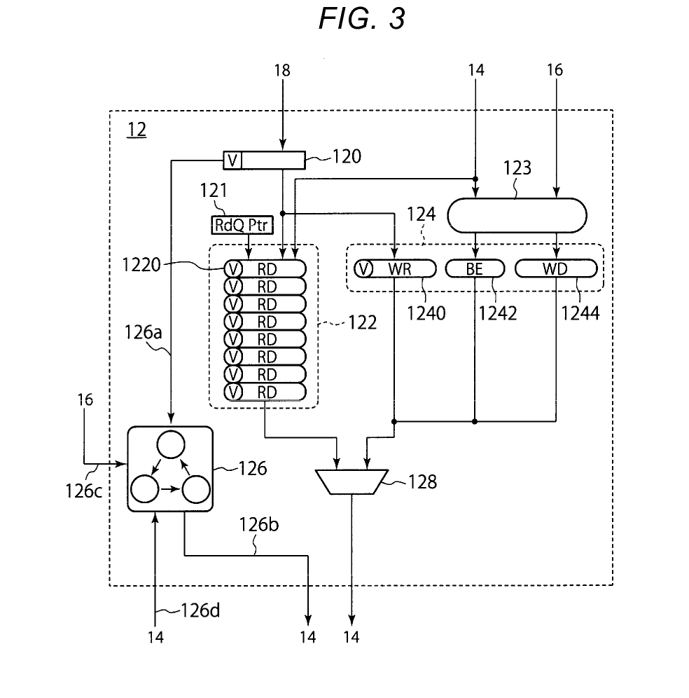

FIG. 3 is a block diagram of the lock transaction controller 12 which supports a single writing request according to the first embodiment. The lock transaction controller 12 includes: a waiting queue that contains access requests and lock requests to a locked region that are in a wait state; and a path over which a waiting request that waits in the waiting queue is reissued to the memory access bridge 14. That is, the lock transaction controller 12 is configured to control the waiting queue and the reissuing of a waiting request. To be more specific, the lock transaction controller 12 includes: a portal queue 120; the waiting queue (reading queue 122 and writing queue 124); a read pointer circuit 121; a write-updating logic 123; a state machine 126; and an output selector 128.

An output (read access information RD of a reading request or write access information WR of a writing request) of the memory access arbiter 18 is first stored in the portal queue 120. The output of the memory access arbiter 18 contains: a request address that indicates an access destination in the shared memory SM; a lock request flag indicating the presence or the non-presence of a lock request; an unlock flag indicating whether or not a request is an unlock writing request (e.g., the set portion of a Test and Set (TAS) request); an identification flag indicating a type of access request (a reading request or a writing request); a burst flag indicating whether or not a burst writing request is necessary; and a bridge Identification (ID) indicating the memory access bridges 140 to 143 which have received an access request.

The reading queue 122 includes a plurality of read access information storage parts 1220. A plurality of read access information RD are stored in each read access information storage part 1220 as individual queue entries. Read pointers of the reading requests stored in the reading queue 122 are stored in the read pointer circuit 121. The read pointer indicates the queue position of the reading request stored in the reading queue 122.

The write-updating logic 123 extracts information (a byte enable BE and writing data WD) for updating the writing queue 124 for a writing request.

In the writing queue 124, a plurality of writing requests are stored such that the plurality of writing requests are integrated in one queue entry. The writing queue 124 includes: a write access information storage part 1240; a byte enable storage part 1242; and a writing data storage part 1244. In the write access information storage part 1240, write access information WR of a writing request (i.e., a standard writing request or an unlock writing request for the locked region), which is input to the lock transaction controller 12, is stored. In the byte enable storage part 1242, a byte enable BE of the writing request is stored. In the writing data storage part 1244, writing data WD of the writing request is stored.

With respect to the standard writing request for the locked region before the lock is released, the write-updating logic 123 does not update the write access information storage part 1240 and, hence, the content of the writing request is reflected only in the byte enable storage part 1242 and the writing data storage part 1244.

The output selector 128 selectively outputs an output of the reading queue 122 and an output of the writing queue 124 to the memory access bridges 140 to 143.

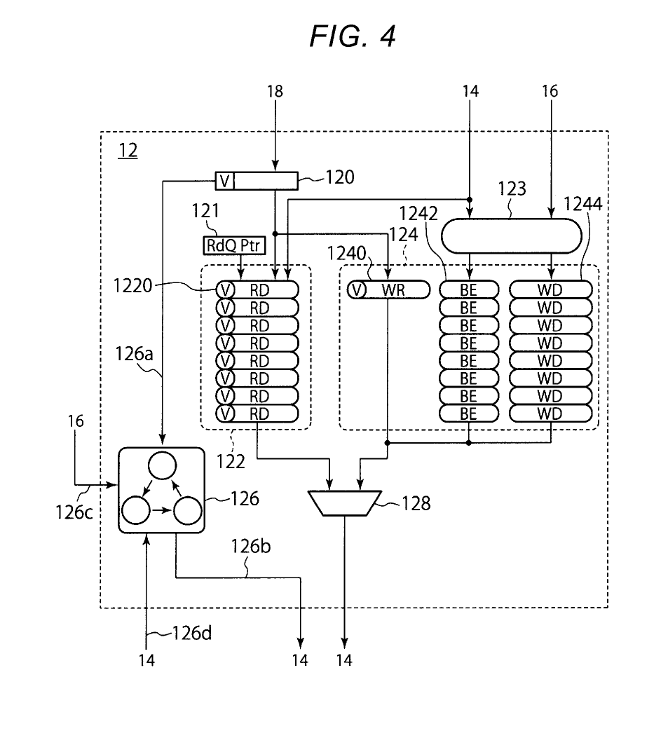

FIG. 4 is a block diagram of the lock transaction controller 12 which supports a burst writing request according to this embodiment. The portal queue 120; the read pointer circuit 121; the reading queue 122; the write-updating logic 123; the state machine 126; and the output selector 128 shown in FIG. 4 are the same as those shown in FIG. 3.

The writing queue 124 includes: a write access information storage part 1240; a plurality of byte enable storage parts 1242; and a plurality of writing data storage parts 1244. The write access information storage part 1240 shown in FIG. 4 is the same as that shown in FIG. 3.

In each byte enable storage part 1242, a byte enable BE of a writing request is stored. In each writing data storage part 1244, writing data WD of a standard writing request is stored.

The manner of operation of the write-updating logic 123 of this embodiment is explained. Hereinafter, an example is explained where the write-updating logic 123 updates the byte enable storage part 1242 and the writing data storage part 1244 within a period from a point in time t1 at which a single writing request for the locked region (address “0x0001_{—}0000”) first arrives at the writing queue 124 to points in time t2 to t4, which follow the point in time t1. In the explanation made hereinafter, it is assumed that the byte enable BE is 8 bits and writing data WD is 64 bits.

First, when a standard writing request (write address “0x0001_{—}0000”, writing data WD “0x1234_{—}5678_{—}9abc_def0” and byte enable BE “0xf0”) not accompanying unlocking is input at the time t1, the byte enable BE “0xf0” is stored in the byte enable storage part 1242, and the writing data WD “0x1234_{—}5678_{—}0000_{—}0000” is stored in the writing data storage part 1244.

Next, when a normal writing request (write address “0x0001_{—}0000”, byte enable BE “0x03” and writing data WD “0xdef0_{—}9abc_{—}5678_{—}1234”) is input at the time t2 (>t1), the byte enable BE “0xf3” is stored in the byte enable storage part 1242, and the writing data WD “0x1234_{—}5678_{—}0000_{—}1234” is stored in the writing data storage part 1244.

Next, when a normal writing request (write address “0x0001_{—}0000”, byte enable BE “0x10” and writing data WD “0x9abc_def0_{—}1234_{—}5678”) is input at the time t3 (>t2), the byte enable BE “0xf3” is stored in the byte enable storage part 1242, and the writing data WD “0x1234_{—}56f0_{—}0000_{—}1234” is stored in the writing data storage part 1244.

When the unlock writing request (write address “0x0001_{—}0000”, byte enable BE “0x08” and writing data WD “0x5678_{—}1234_def0_{—}9abc”) is input at a time t4 (>t3), the new byte enable BE “0x08” input at the time t4 does not overlap with the existing byte enable BE “0xf3” which is stored in the byte enable storage part 1242 at the time t3 and, hence, a portion of new writing data WD “0x5678_{—}1234_def0_{—}9abc” corresponding to the byte enable BE is written in the writing data storage part 1244, whereby the writing data storage part 1244 stores “0x1234_{—}56f0_de00_{—}1234”, and the byte enable BE “0xfb” is stored in the byte enable storage part 1242.

However, if the unlock writing request (write address “0x0001_{—}0000,”, the byte enable BE “0x01” and the writing data WD “0x5678_{—}1234_def0_{—}9abc”) are input at time t4, the new byte enable BE “0x01” overlaps with the existing byte enable BE “0xf3” and, hence, the portion of new writing data WD “0x5678_{—}1234_def0_{—}9abc” corresponding to the byte enable BE is not written in the writing data storage part 1244, so that the writing data at the time t3 is held. In this case, the byte enable storage part 1242 also holds the byte enable at the time t3.

In this manner, the write-updating logic 123 performs writing to the writing data storage part 1244 when the existing byte enable BE and the byte enable BE of the unlock writing request do not overlap with each other. However, when the existing byte enable BE and the byte enable BE of the unlock writing request do overlap, the write-updating logic 123 does not perform a write into the writing data storage part 1244 and, hence, the order of processing (where the standard writing request waits and is processed after the unlocking of the locked region, may be maintained.

Due to the processing described above, it is possible to guarantee the order of writing write data WD contained in a writing request into the shared memory SM. When the shared memory SM is a shared cache memory, a write burst length is a cache line length, and a region to be locked is set in accordance with every cache line and hence, with the use of the writing data storage part 1244 and the write byte enable storage part 1242 having a cache line length, it is possible to support a burst write while guaranteeing the order of writing write data WD into the shared memory SM using the same processing.

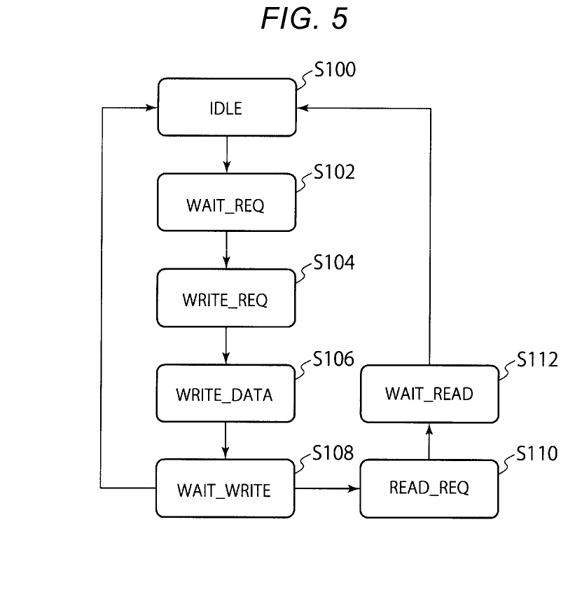

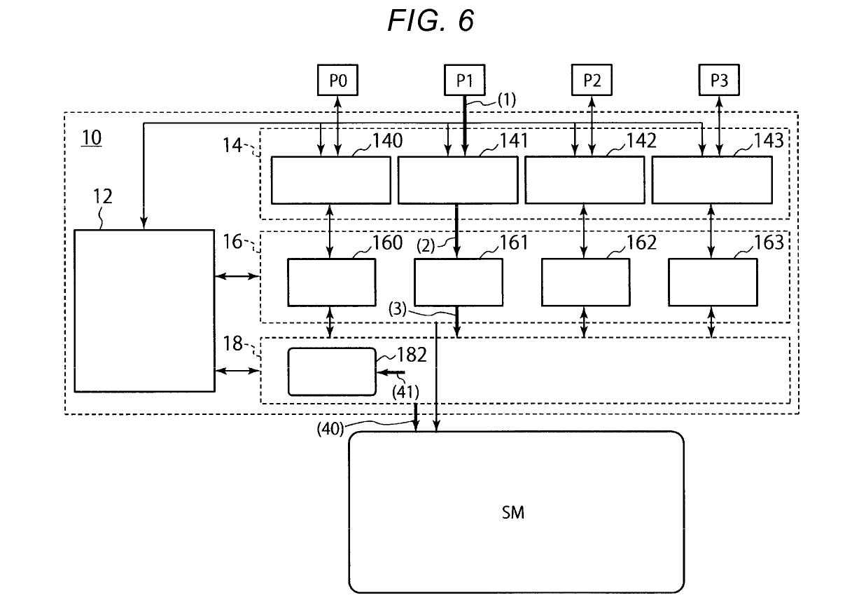

The flow of the lock transaction according to the first embodiment is explained. FIG. 5 is a flowchart showing the transition of the state machine 126 of the first embodiment. FIGS. 6 to 11 are block diagrams showing the manner how data is transferred in the shared memory control unit 10 during the execution of a lock transaction according to the first embodiment.

As shown in FIG. 5, a state machine in the execution flow of a lock transaction includes: an IDLE state (S100); a WAIT_REQ state (S102); a WRITE_REQ state (S104); a WRITE_DATAstate(S106); a WAIT_WRITE state (S108); a READ_REQ state(S110); and a WAIT_READ state(S112). The lock transaction controller 12 operates according to the respective states (S100 to S112) and controls the data transfer between the master devices MD and the shared memory SM, and a lock state (lock/unlock) of the shared memory SM.

As shown in FIG. 6, a lock reading request arrives at the memory access bridge 141 from the master device MD0 via the port P1 ((1) in FIG. 6), and arrives at the memory access arbiter 18 through the memory access part 161 ((2) and (3) in FIG. 6). When the memory access arbiter 18 receives the lock reading request, the memory access arbiter 18 transmits the lock reading request to the shared memory SM ((40) in FIG. 6). In addition, inside of the memory access arbiter 18, lock information (including information on the presence or non-presence of locking, an address to be locked, and lock master IDs of master devices that are lock origins) is stored in the lock information storage part 182 ((41) in FIG. 6).

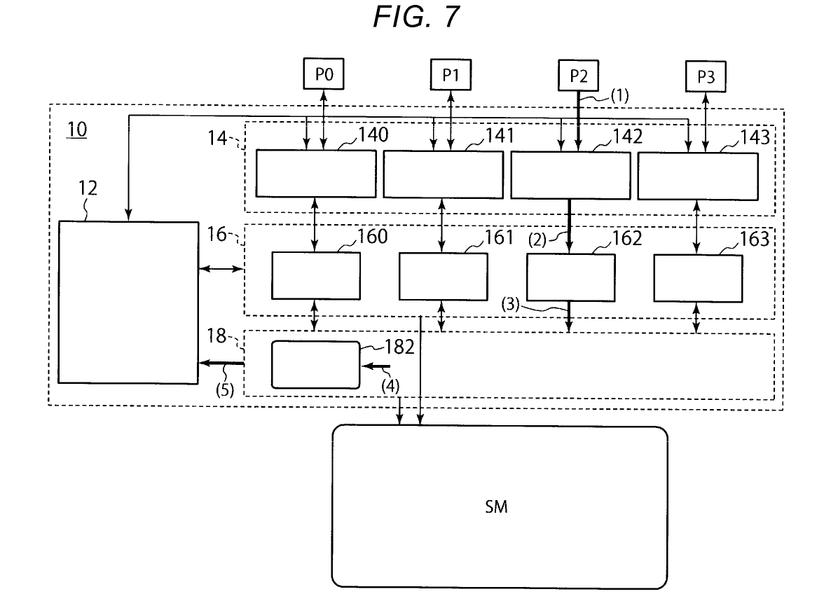

Thereafter, when a new access request (a reading request, a writing request having a different lock master ID (a writing request not requesting releasing of lock) or a new lock reading request (regardless of address)) arrives at a region to be locked in the shared memory SM, as shown in FIG. 7, the new access request arrives at the memory access bridge 142 via the port P2 ((1) in FIG. 7), and arrives at the memory access arbiter 18 through the memory access part 162 ((2) and (3) in FIG. 7). When the new access request is received by the memory access arbiter 18, the memory access arbiter 18 examines lock information in the lock information storage part 182 ((4) in FIG. 7) to determine if the new access request corresponds to a locked address. When it is determined that it is necessary to make the new access request wait, the new access request is transmitted to the lock transaction controller 12, and is stored in the waiting queue ((5) in FIG. 7). More specifically, in the case where the new access request is a reading request or a writing request, when the new access request corresponds to a locked address, it is determined that it is necessary for the new access request to wait. In some embodiments, when the new access request is a lock reading request, it is determined that the new access request must wait regardless of the result of the comparison. That is, lock transaction controller 12 does not process two lock reading requests simultaneously. Thus, in such embodiments, subsequent lock reading requests received after an initial lock reading request are required to wait.

To facilitate the understanding of the description made hereinafter, it is assumed that a reading request to a region to be locked arrives at the shared memory control unit 10 as a new access request.

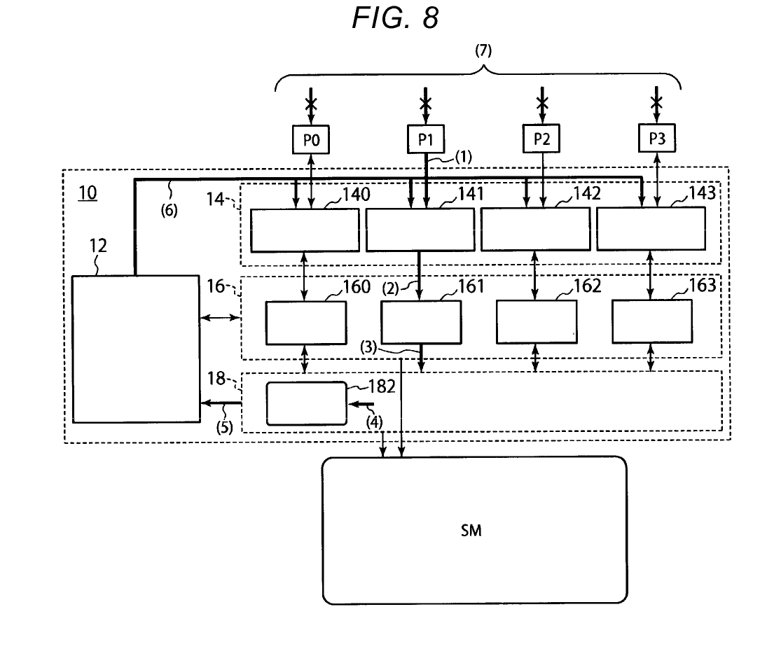

Then, as shown in FIG. 8, an unlock writing request arrives at the memory access bridge 141 via the port P1 from the master device MD0 which issues a lock reading request ((1) in FIG. 8), and arrives at the memory access arbiter 18 through the memory access part 161 ((2) and (3) in FIG. 8). When the memory access arbiter 18 receives the unlock writing request, the memory access arbiter 18 compares the unlock writing request with lock information stored in the lock information storage part 182 ((4) in FIG. 8), and when the unlock writing request matches the lock information as the result of the comparison (when it is confirmed that the unlock writing request is an unlock request), the unlock writing request is transmitted to the lock transaction controller 12 with an assertion through an unlock request line (indicated by symbol 126a in FIG. 3 or FIG. 4), and is stored in the writing queue 124 in the lock transaction controller 12 ((5) in FIG. 8).

When the unlock writing request arrives at the lock transaction controller 12, the state machine 126 in FIG. 5 transitions to the WAIT_REQ state(S102) from the IDLE state(S100).

In this stage, the lock transaction controller 12 outputs a temporary stop instruction to temporarily stop the reception of new access requests to the memory access bridges 140 to 143 via a temporary stop line (indicated by symbol 126b in FIG. 3 or FIG. 4) on a path (6) shown in FIG. 8. The memory access bridges 140 to 143 that receive the temporary stop instruction respectively close the ports P0 to P3 and, hence, the reception of all new access requests is temporarily stopped regardless of the address in the request ((7) in FIG. 8).

Then, the lock transaction controller 12 waits until remaining requests in the memory access bridge 14 and the memory access part 16 arrive at the memory access arbiter 18.

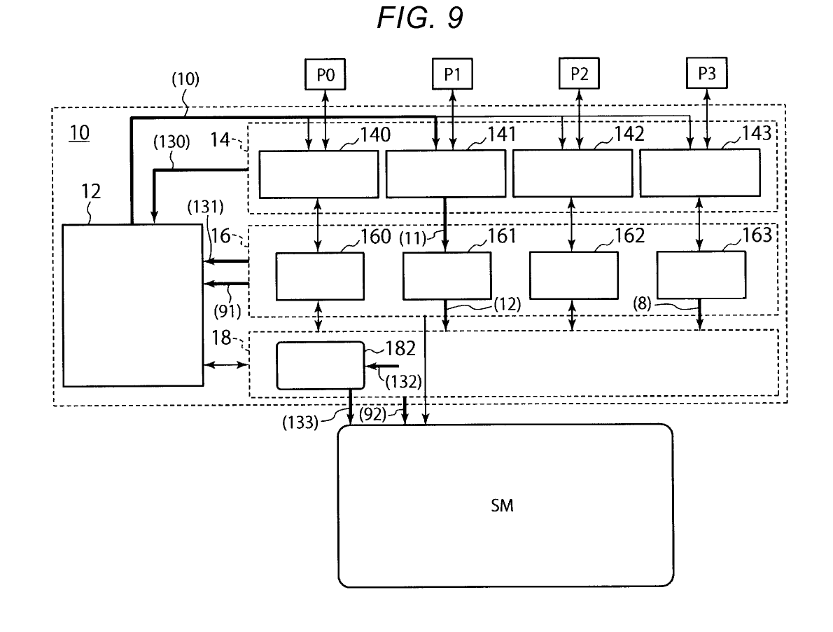

As shown in FIG. 9, when the remaining requests arrive at the memory access arbiter 18 ((8) in FIG. 9), the memory access part 16 transmits access completion notification to the lock transaction controller 12 via an access completion notifying line (126c in FIG. 3 or FIG. 4) thus notifying that the remaining requests are received by the memory access arbiter 18 ((91) in FIG. 9).

When access completion notification arrives at the lock transaction controller 12, the state machine 126 in FIG. 5 transits to the WRITE_REQ state(S104) from the WAIT_REQ state(S102).

As a result of this transition of the state machine 126, the lock transaction controller 12 inputs again a writing request which is obtained by integrating an unlock writing request stored in the writing queue 124 and an existing writing request that waits before the unlock writing request is stored to the memory access bridge 141 (that is, a memory access bridge through which the unlock writing request passes) ((10) in FIG. 9). The re-input writing request arrives at the memory access arbiter 18 through the memory access part 161 ((11) and (12) in FIG. 9).

When the writing request that is input again arrives at the memory access arbiter 18, the memory access bridge 14 asserts a reception signal to the lock transaction controller 12 via a reception notification line (indicated by symbol 126d in FIG. 3 or FIG. 4) ((130) in FIG. 9).

When the reception signal is asserted, the state machine 126 in FIG. 5 transits to the WRITE_DATA state (S106) from the WRITE_REQ state (S104).

Then, the lock transaction controller 12 outputs writing data WD and byte enable BE to the memory access bridge 14. When the writing data WD and the byte enable BE arrive at the memory access bridge 14, the memory access bridge 14 asserts a reception signal to the lock transaction controller 12 via the reception notification line 126d.

When the reception signal is asserted, the state machine 126 in FIG. 5 transits to the WAIT_WRITE state(S108) from the WRITE_DATA state(S106), and waits until the reissued unlock writing request arrives at the memory access arbiter 18.

When the re-input unlock writing request arrives at the memory access arbiter 18, information stored in the lock information storage part 182 is deleted ((132) in FIG. 9), the unlock writing request is transmitted to the shared memory SM ((133) in FIG. 9), and the unlocking of a region to be locked is performed. Next, the memory access part 16 transmits access completion notification to the lock transaction controller 12 via an access completion notification line (indicated by symbol 126c in FIG. 3 or FIG. 4) thus notifying that the re-input unlock writing request is received by the memory access arbiter 18 ((131) in FIG. 9).

When the access completion notification arrives at the lock transaction controller 12, since, in this embodiment, a reading request exists in the reading queue, the state machine 126 shown in FIG. 5 transits to the READ_REQ state(S110) from the WAIT_WRITE state(S108). When there is no reading request in the reading queue 122, the state machine 126 transits to the IDLE state(S100) from the WAIT_WRITE state(S108).

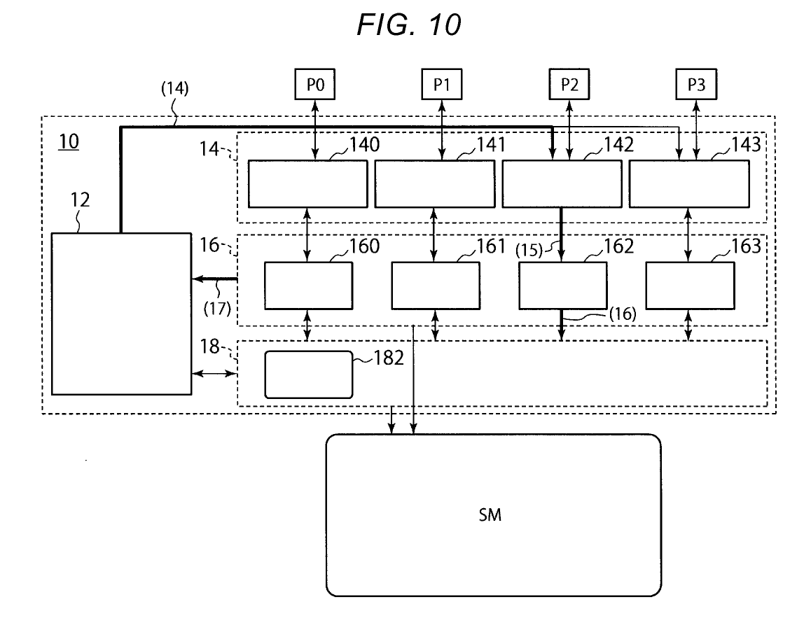

As shown in FIG. 10, due to the transition of the state machine 126 to the READ_REQ state(S110), the lock transaction controller 12 outputs a reading request stored in the reading queue 122 to the memory access bridge 142 ((14) in FIG. 10). Thereafter, the reading request arrives at the memory access arbiter 18 through the memory access part 162 ((15) and (16) in FIG. 10).

The lock transaction controller 12 determines whether or not the reading request output in (14) in FIG. 10 is the last reading request (a reading request which is output last out of the reading requests stored in the reading queue 122) based on a pointer stored in the read pointer circuit 121. When the memory access bridge 142 notifies the lock transaction controller 12 of the reception of the reading request by the memory access arbiter 18 by asserting a reception signal to lock transaction controller 12, and it is determined, based on the read pointer, that the reading request output in (14) in FIG. 10 is a last reading request, a determination is made that the last reading request is received at this stage ((17) in FIG. 10).

When the reception signal for the last reading request is asserted, the state machine 126 in FIG. 5 transits to the WAIT_READ state(S112) from the READ_REQ state(S110).

When the access completion notification arrives at the lock transaction controller 12, the state machine 126 transits to the IDLE state(S100) from the WAIT_READ state(S112).

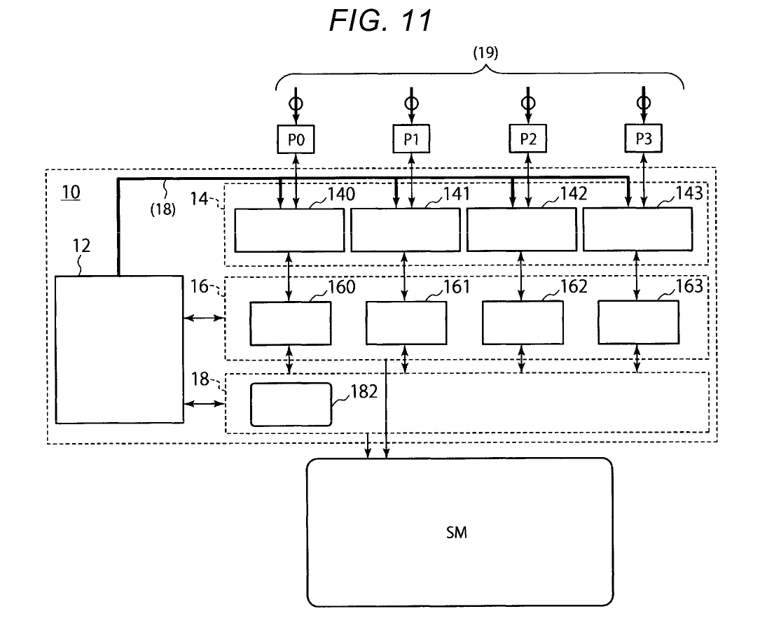

When the state machine 126 returns to the IDLE state(S100), as shown in FIG. 11, the temporarily stop line (indicated by symbol 126d in FIG. 3 or FIG. 4) arranged on the path (18) in FIG. 11 from the lock transaction controller 12 to the memory access bridges 140 to 143 is de-asserted. Accordingly, it is possible for the memory access bridges 140 to 143 to receive new access requests ((19) in FIG. 11).

According to this embodiment, it is possible to improve the data transfer efficiency of the system that includes a plurality of master devices and a shared memory.

At least some parts of the multiprocessing system 1 according to this embodiment may be designed by hardware or software. When the part of the multiprocessing system 1 is constituted of software, a program for realizing at least some functions of the multiprocessing system 1 may be stored in a recording medium such as a flexible disc or a CD-ROM and the program may be executed by a program readable computer. The recording medium is not limited to a recording medium which is detachable such as a magnetic disc or an optical disc, and may be a fixed-type recording medium such as a hard disc device or a memory.

Further, a program which realizes at least some functions of the multiprocessing system 1 according to this embodiment may be distributed via communication lines (including wireless communication) such as the internet. Further, such a program may be distributed via a wire line or a wireless line such as the internet in a state where the program is encrypted, modulated or compressed, or may be distributed in a state where the program is stored in a recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A shared memory control unit that controls access to a shared memory by a plurality of master devices based on access requests received from the plurality of master devices, the shared memory control unit comprising:
a memory access arbiter configured to receive a lock reading request to lock a portion of the shared memory;
a waiting queue that stores the access requests; and
a lock transaction controller configured to (i) receive a plurality of access requests after the lock reading request is received by the memory access arbiter, (ii) store the access requests in the waiting queue, (iii) receive an unlock writing request to unlock the portion of shared memory, and (iv) release the access requests from the waiting queue after the portion of shared memory is unlocked.

2. The shared memory control unit of claim 1, wherein the lock transaction controller is further configured to output the unlock writing request to the shared memory to release the lock on the portion of shared memory,
wherein the lock transaction controller releases the access requests from the waiting queue by outputting the access requests stored in the waiting queue to the shared memory after outputting the unlock writing request to the shared memory.

3. The shared memory control unit of claim 2, wherein the waiting queue includes a reading queue that stores reading requests, a writing queue that stores writing requests, and a write-updating logic unit configured to extract information from received writing requests and update the writing queue based on the extracted information.

4. The shared memory control unit of claim 3, wherein the access requests include one or more reading requests that are stored in the reading queue as a plurality of individual queue entries and one or more writing requests that each include write data, and that are integrated by the write-updating logic unit and stored in the writing queue as one integrated queue entry.

5. The shared memory control unit according of claim 4, wherein one of the received writing requests is the unlock writing request, and wherein the write-updating logic unit is configured to update the writing queue to ensure that the lock reading request and the unlock writing request are processed atomically.

6. The shared memory control unit of claim 5, wherein the write-updating logic unit is further configured to update the writing queue based on a byte enable field.

7. The shared memory control unit of claim 6, wherein the lock transaction controller is further configured to:
responsive to receiving the unlock writing request, issue an instruction to disable the shared memory controller from receiving new access requests; and
output the unlock writing request to the shared memory based on information stored in the writing queue.

8. The shared memory control unit of claim 7, wherein the lock transaction controller is further configured to:
output one or more reading requests stored in the reading queue to the shared memory; and
issue an instruction to enable the shared memory controller to receive new access requests.

9. A method of operating a shared memory controller that controls access to a shared memory by a plurality of master devices based on access requests received by the shared memory controller from the plurality of master devices, the method comprising:
receiving a lock reading request to lock a portion of the shared memory;
receiving a plurality of access requests after receiving the lock reading request;
storing the access requests in a waiting queue;
receiving an unlock writing request to unlock the portion of shared memory; and
releasing the access requests from the waiting queue after the portion of shared memory is unlocked.

10. The method of claim 9, further comprising outputting the unlock writing request to the shared memory to release the lock on the portion of shared memory, wherein
the releasing of the access requests from the waiting queue comprises outputting the access requests stored in the waiting queue to the shared memory after outputting the unlock writing request to the shared memory.

11. The method of claim 10, wherein the waiting queue includes a reading queue that stores reading requests, a writing queue that stores writing requests, and a write-updating logic unit that extracts information from received writing requests and updates the writing queue based on the extracted information.

12. The method of claim 11, wherein the received access requests include one or more reading requests and one or more writing requests, the writing requests each including write data, and the method further comprises:
storing the read requests in the reading queue as a plurality of individual queue entries;
integrating the write requests; and
storing the write requests in the writing queue as one integrated queue entry.

13. The method of claim 12, wherein one of the received writing requests is the unlock writing request, and the method further comprises updating the writing queue to ensure that the lock request and the unlock writing request are processed atomically.

14. The shared memory control unit of claim 13, wherein the updating of the writing queue is based on a byte enable field.

15. The method of claim 14, further comprising:
responsive to receiving the unlock writing request, disabling the shared memory controller from receiving new access requests; and
outputting the unlock writing request to the shared memory based on information stored in the writing queue.

16. The method of claim 15, further comprising:
outputting one or more reading requests stored in the reading queue to the shared memory; and
enabling the shared memory controller to receive new access requests.
